(19) United States
(12) Patent Application Publication
(10) Pub. No.: US 2014/0068437 A1
(43) Pub. Date: Mar. 6, 2014

(54) COMPUTERIZED SYSTEM AND METHOD OF COMMUNICATING ABOUT DIGITAL CONTENT

(71) Applicant: ZAZOOM, LLC, New York, NY (US)

(72) Inventors: JAY DEDAPPER, NEW YORK, NY (US); PHILIP O'BRIEN, FLUSHING, NY (US); STEVE BRADBURY, Hastings-on-Hudson, NY (US); CYRUS MAAGHUL, Addison, TX (US); MARK VAN NOTE, Minneapolis, MN (US); TIM MINTON, New York, NY (US); RACHEL TROBMAN, Brooklyn, NY (US)

(73) Assignee: ZAZOOM, LLC, New York, NY (US)

(21) Appl. No.: 14/018,038

(22) Filed: Sep. 4, 2013

Related U.S. Application Data
(60) Provisional application No. 61/697,364, filed on Sep. 6, 2012.

(51) Int. Cl. H04L 29/06

(52) U.S. Cl. CPC H04L 65/40
USPC 715/719

(57) ABSTRACT

A computerized system and method for communicating about digital content. In one embodiment, the system allows users to view and post video comments about source digital content. Typically, the source digital content and associated videos comments are assigned unique identifications so the relationships among videos can be stored in a central database. This means that video comments about source digital content can be decentralized since the source digital content has unique identifiers throughout websites and the relationship with any associated videos can be determined based on relationships stored in the database.

### RELATED APPLICATIONS

This application claims the benefit of U.S. Provisional Application Ser. No. 61/697,364, filed Sep. 6, 2012 entitled “Computerized System and Method of Communicating About Digital Content,” which is hereby incorporated by reference in its entirety.

### FIELD OF THE INVENTION

The present invention relates generally to computerized systems and methods for communicating about digital content accessible via a communications network. In one embodiment, the invention relates to a computer-based system that allows video comments to be created and posted by a user such that the comments are associated with source digital content.

### BACKGROUND AND SUMMARY OF THE INVENTION

Computer-based video recording tools have been available for some time. Sharing videos created with these tools to friends and family through video sharing websites, such as YouTube™, has become commonplace. These sites include not just family videos, but original content about news, entertainment and sports, among other topics. One shortcoming of these video sharing sites, however, is the centralized nature that drives traffic solely to these sharing sites.

Another type of video posted to these sharing websites is product reviews. Many potential consumers search these sites looking for information about a particular product that they are considering purchasing. Although these videos often provide helpful information, this tends to drive traffic away from the e-commerce websites that are actually selling the products. Moreover, the comments and recommendations provided in these videos can be somewhat dubious to a potential customer because there is no relationship with the person giving the review, which injects uncertainty into the purchasing process.

Many news organizations often publish original videos purchased from third party content providers. This results in the same third party videos appearing on a multiplicity of news websites. Although many of these websites include commenting systems that allow users to react, comment or provide opinions about the videos, these commenting systems post user comments only to the website on which the comment was received. There is no way with existing commenting systems to view all of the comments about the same third party video from the numerous websites on which that video appears.

One aspect to the present invention is a computerized system and method for communicating about digital content. In one embodiment, for example, the system allows users to view video comments about source digital content, such as a video from a webpage; preferably, the user has the ability to post his/her own reaction or opinion about the source digital content. In one embodiment, the user is presented with a tool that allows recording and posting of a video comment that becomes associated with the source digital content. Typically, the source digital content and associated videos are assigned unique identifications so the relationships among videos can be stored in a central database. When a user requests viewing of video comments about the source digital content, the relationship between the source digital content and any associated videos are retrieved from the database and sent to the user. In some embodiments, this means that video comments about source digital content can be decentralized since the source digital content has unique identifiers throughout websites and the relationship with any associated videos can be determined based on relationships stored in the database.

Certain embodiments of the system and method do not require a decentralized approach. In an e-commerce environment, for example, product information will not typically be identified as the same across e-commerce websites. However, relationships between a potential consumer and those that have posted video comments about a product can be leveraged using the social graph to enhance sales of the product. For example, a potential consumer will more likely purchase a product based on a friend or family member's recommendation, which could be established using the social graph.

Additional features and advantages of the subject system and method will become apparent to those skilled in the art upon consideration of the following detailed materials which form part of this provisional application.

### BRIEF DESCRIPTION OF THE DRAWINGS

The present disclosure will be described hereafter with reference to the attached drawings which are given as non-limiting examples only, in which:

FIG. 1 is a diagrammatic view of a possible relationship between source digital content and a plurality of associated video comments according to one embodiment of the present invention.

FIG. 2 is a flow chart showing possible steps that could be taken by a user to view video comments and/or post a new video comment according to one embodiment of the present invention.

FIGS. 3-14 are screenshots illustrating a user interface for the client module according to one embodiment of the present invention.

FIG. 15 is a diagrammatic view of a decentralized system for viewing and/or posting video comments in response to source digital content according to one embodiment of the present invention.

FIG. 16 is a diagrammatic view of a system for viewing and/or posting video product reviews that uses relationships in a social network between authors of the product reviews and potential consumers according to one embodiment of the present invention.

FIG. 17 is a diagrammatic view of a system for communicating about webinar content according to one embodiment of the present invention.

FIG. 18 is a diagrammatic view of a system for viewing and/or posting video comments in response to source digital content according to one embodiment of the present invention.

FIG. 19 is a diagrammatic view showing interactions between the admin module and digital content providers according to one embodiment of the present invention.

FIG. 20 is a diagrammatic view of showing interactions between a user and the client module according to one embodiment of the present invention.

FIG. 21 is a diagrammatic view showing an example machine on which the methods and features described herein could be performed.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

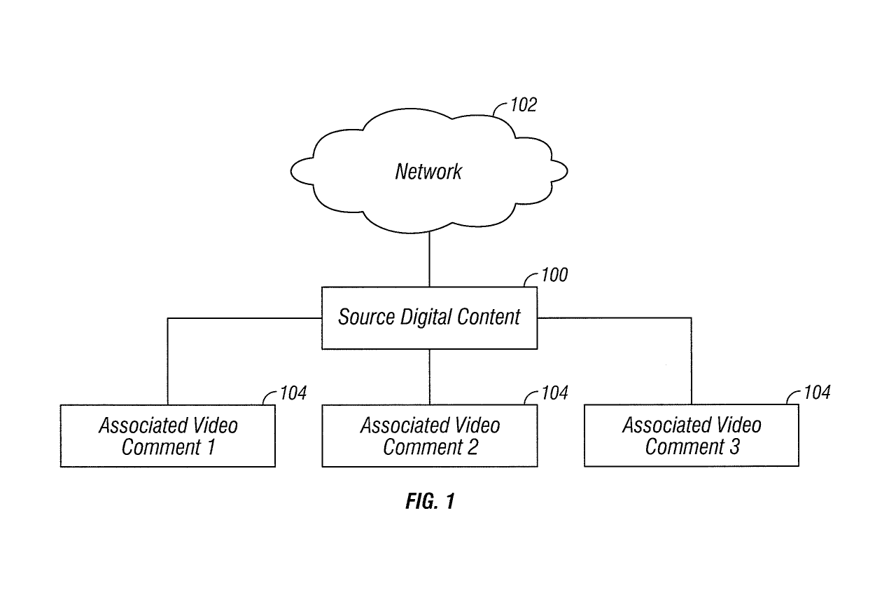

This disclosure relates generally to a computerized system and method of communicating about digital content. As discussed below, the system and method allows users to communicate with others about digital content such as by posting opinions, reactions, or comments about the digital content. In the embodiment shown in FIG. 1, source digital content 100 may be accessible over a communications network 102, such as the Internet. The source digital content 100 could come in various forms, such as videos, images, sounds, text and/or combinations thereof. In some cases, the source digital content 100 may be embedded in a webpage, such as a video embedded in a webpage that could be viewed using a plug-in of a web browser, such as Microsoft Internet Explorer™ or Google Chrome™. Embodiments are also contemplated in which the source digital content 100 could be accessed using a dedicated application instead of using a web browser.

As users view the source digital content 100, they may communicate by posting comments that are associated with the source digital content 100. Although the comments could include text and/or sounds, the system preferably allows users to post video comments about the source digital content 100. In the example shown in FIG. 1, a plurality of video comments 104 have been posted that are associated with the source digital content 100. Although this example shows three video comments 104 associated with the source digital content 100, a single video comment or more than one video comment could be associated with the source digital content 100. In some embodiments, the user can view the video comments 102 associated with the source digital content 100 by selecting an element in a webpage, such as a button, that launches an application for viewing and/or posting video communications as explained below.

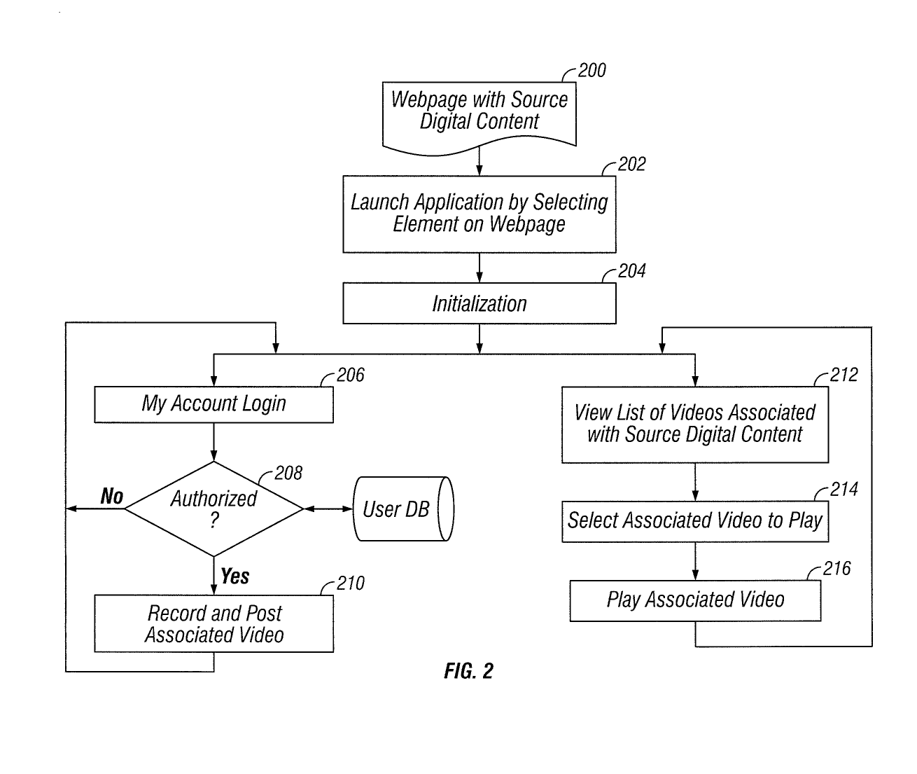

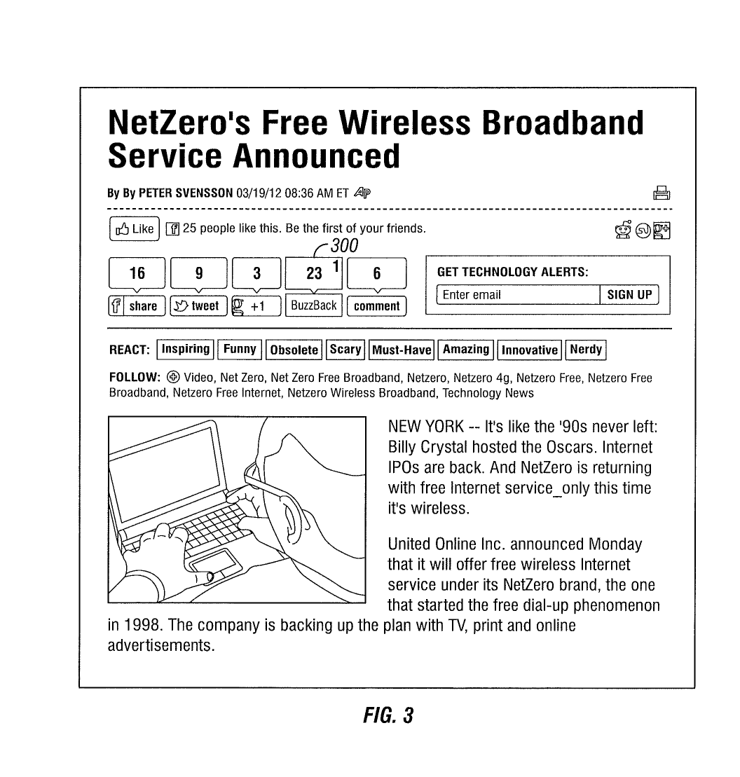

FIG. 2 illustrates an example process by which a user could view and/or post video comments about source digital content according to one embodiment. In the embodiment shown, in which the user accesses the source digital content using a browser, the source digital content may be embedded on a webpage (block 200). FIG. 3 shows an example webpage that includes source digital content in the form of a text article that can be viewed by the user. Although this example uses a text article for purposes of example, the source digital content could be a video, audio or other content. This example page includes element 300, which is a button in this example that can be selected by a user to launch an application. As one of skill in the art should appreciate, the element 300 may be placed on the webpage using an embed code that launches the application. In this example, the element 300 includes optional information about the number of videos associated with the source digital content. For example, the number listed on the element 300 of “23” indicates the number of videos associated with the source digital content at the time. As additional associated videos are posted about the source digital content, this number will be incremented.

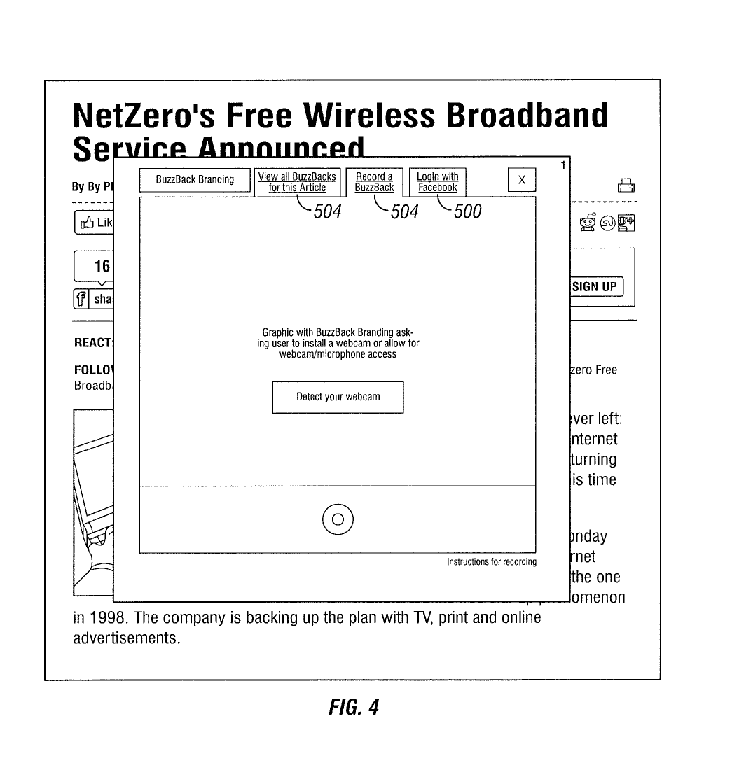

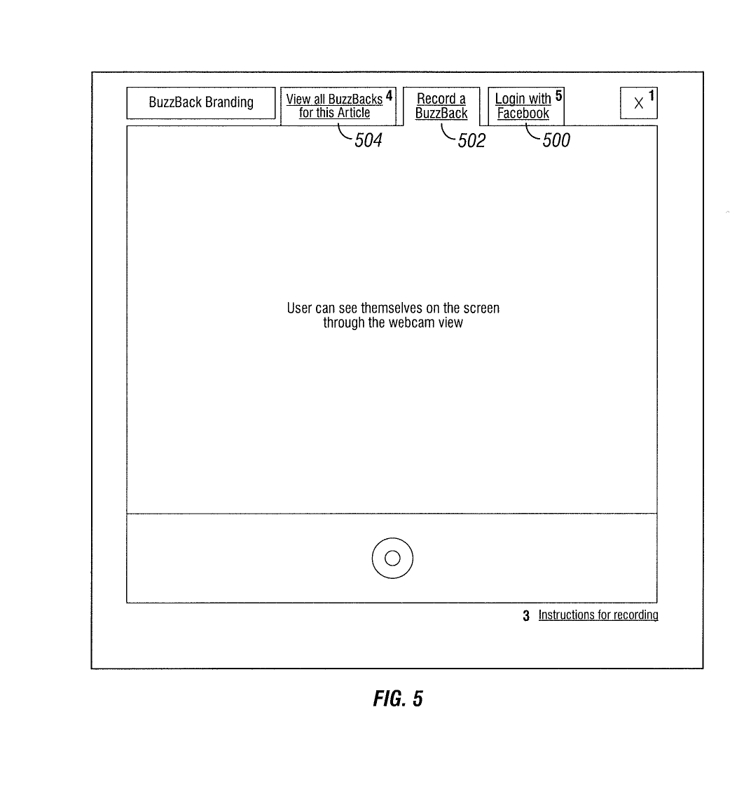

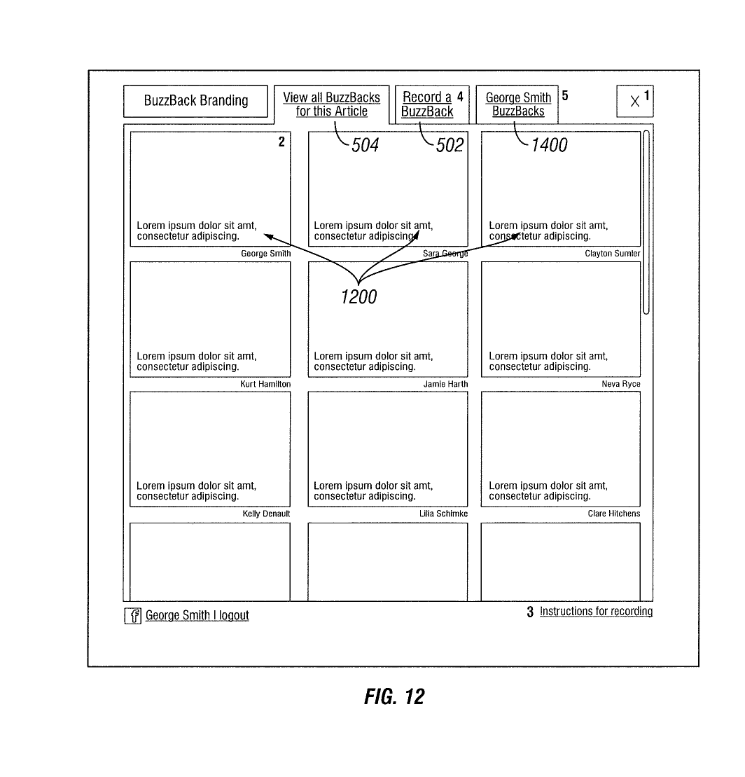

If the user selects the element 300 on the webpage, this will launch an application from which the user may view and/or post one or more videos about the source digital content (block 202). In some cases, the application may include an initialization process upon launch (block 204). FIG. 4 is a screenshot showing an example user interface for the application. In this example, the application has launched and is performing initialization by detecting whether the user has a webcam and will grant authorization for the application to use the webcam and microphone. Once this initialization process has completed, the user may see himself/herself on the screen through the webcam as shown in FIG. 5. In this example, the user may select a login tab 500 which allows the user to login to a social network, such as Facebook™ offered by Facebook, Inc. of Menlo Park, Calif. If the user is logged into his/her account, the user may be able to select a record tab 502 that will allow the user to record a video that could be posted. Instead of logging in, the user could select the view tab 504 to view video comments associated with the source digital content (FIG. 12).

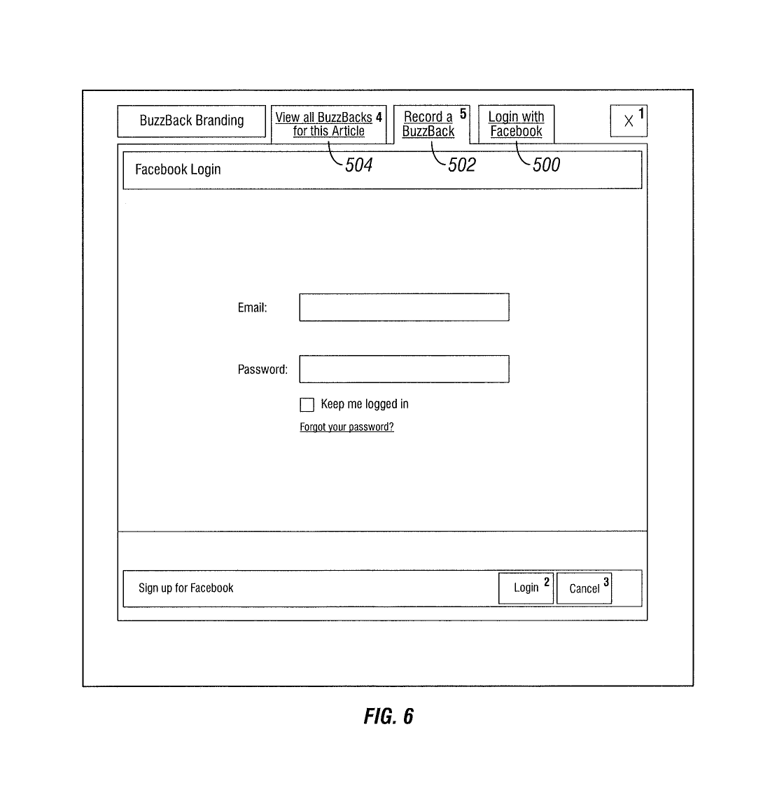

If the user selects the login tab 500, a login page is shown such as the example in FIG. 6. This corresponds to block 206 in FIG. 2. Although this example shows a login screen for a social network, which is Facebook™ in this example, other types of authentication could be used. In this example, the user is asked to provide login credentials, which are an email address and password in this example, and to select the login button. If authorized (block 208 in FIG. 2), the user will be allowed to record and post videos.

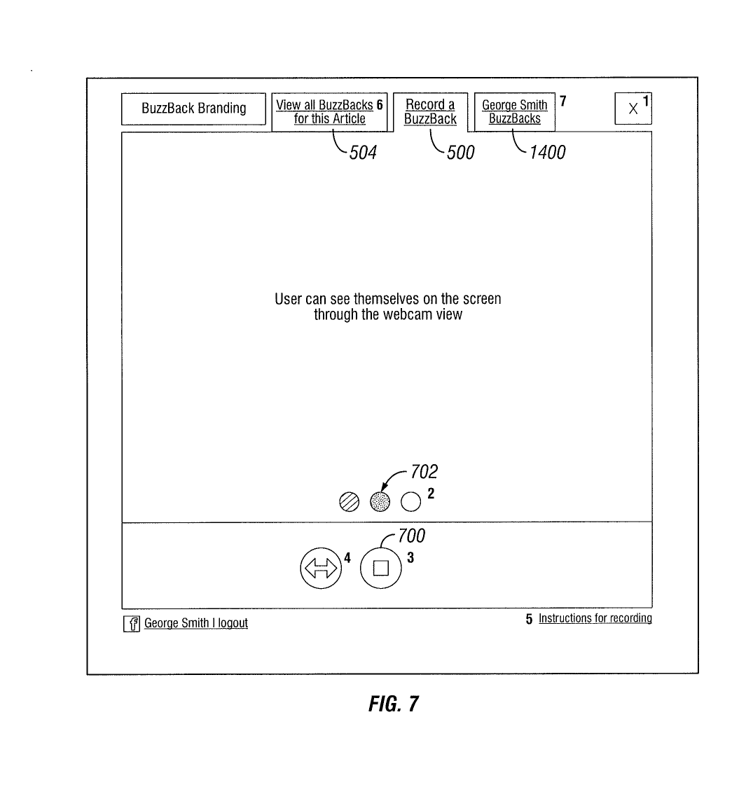

Once the user has been authenticated, the user may record a video comment that could be posted to the system (block 210 in FIG. 2). FIG. 7 shows an example screenshot upon selecting the record tab 502 and selecting the record button 700 (which has changed to a stop button in this figure since the record button has already been selected). In this example, a countdown 702 is provided for the user to be ready when recording starts. FIG. 7 also shows that the login tab 500 has changed to a my comments tab 1400, which allows the user to view comments that he/she has posted, as explained below.

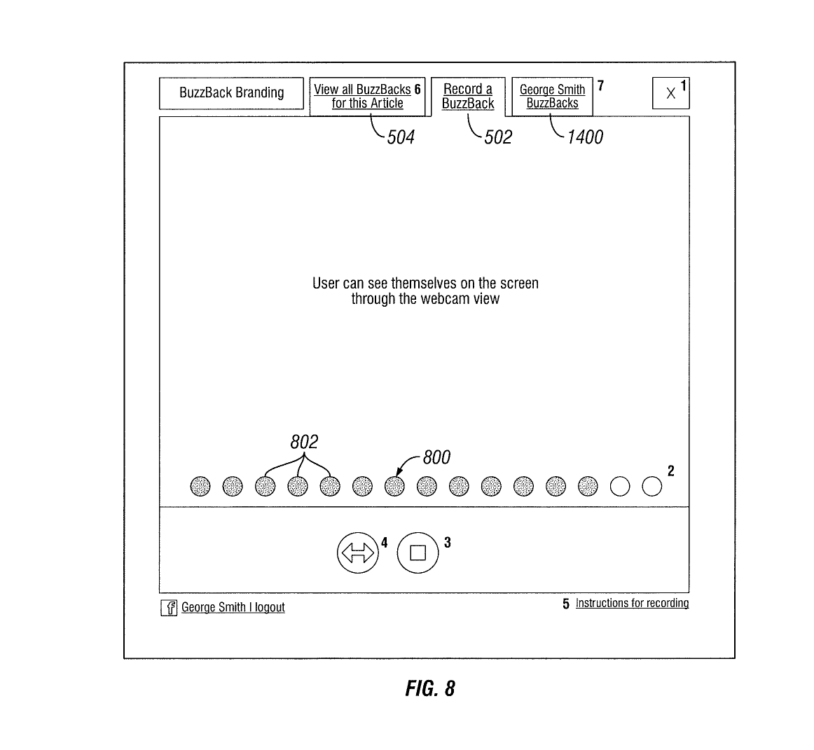

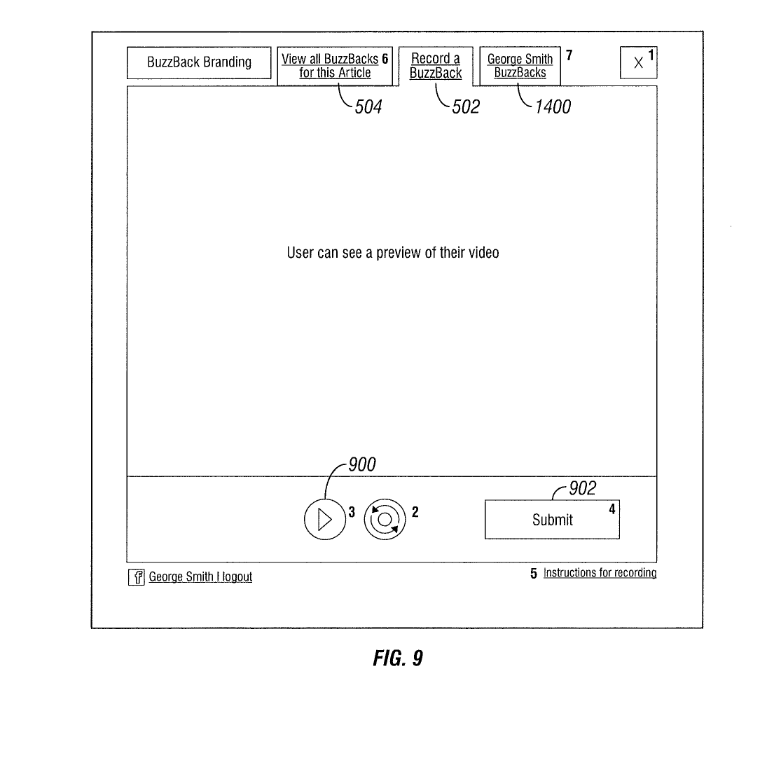

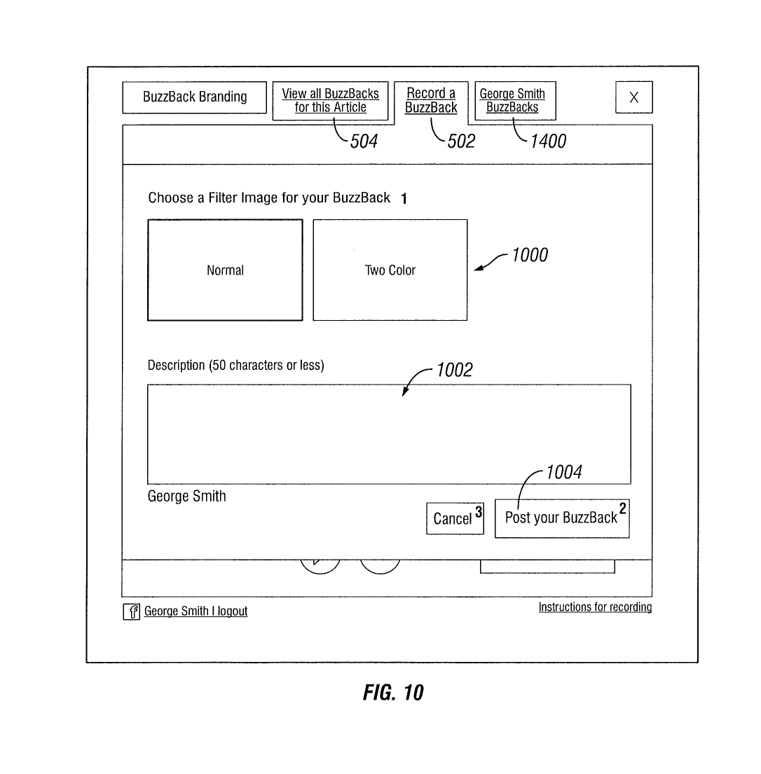

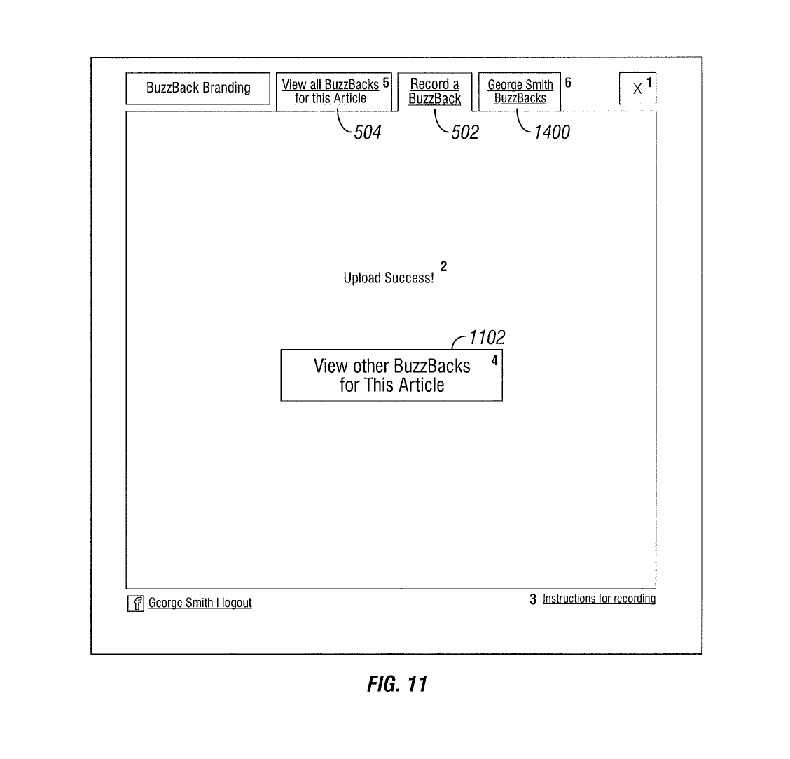

FIG. 8 shows an example screen shot while the user records a video. In this example, the user can see himself/herself on the screen as the video is being recorded. In some cases, the application will limit the length of the video. For example, this example screen shot includes a length indicator 800 from which the user can see how much longer recording can continue. In this example, the length indicator 800 includes a plurality of time increments 802 that change indicia (e.g., color) as the recording is made. In this example, the user can see that two additional time increments 802 are left for recording until the maximum length has been reached. By way of example, the maximum length of each video comment could be restricted in this manner to 15 seconds or some other time length. Prior to posting the recorded video, the user could preview the video as shown in FIG. 9 by selecting the play button 900. Once the user is satisfied with the recorded video, the user may initiate the posting sequence by selecting the submit button 902 in this example. FIG. 10 shows an example screen shot upon selection of the submit button 902. In this example, the user may select certain video editing options 1000. The user may type a description into text box 1002. Once the user is satisfied with the option selected, the user may select the post button 1004, which will initiate the upload process. FIG. 11 shows an example screen shot upon a successful post of the recorded video. In this example, a separate view button 1102 is provided for the user which would function the same as the view tab 504.

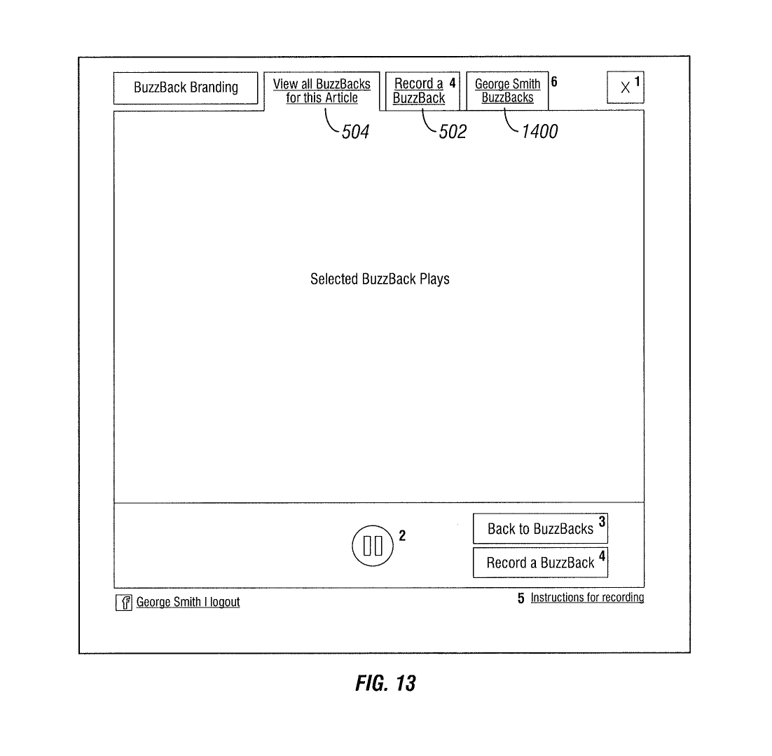

FIG. 12 shows an example screen shot upon selecting the view tab 504. In this example, the videos are listed by displaying a thumbnail 1200 of each video comment that could be selected by the user to view (block 212 in FIG. 2). Upon selecting a thumbnail 1200 in this example (block 214 in FIG. 2), the user may play the selected video comment as shown in FIG. 13 (block 216 in FIG. 2).

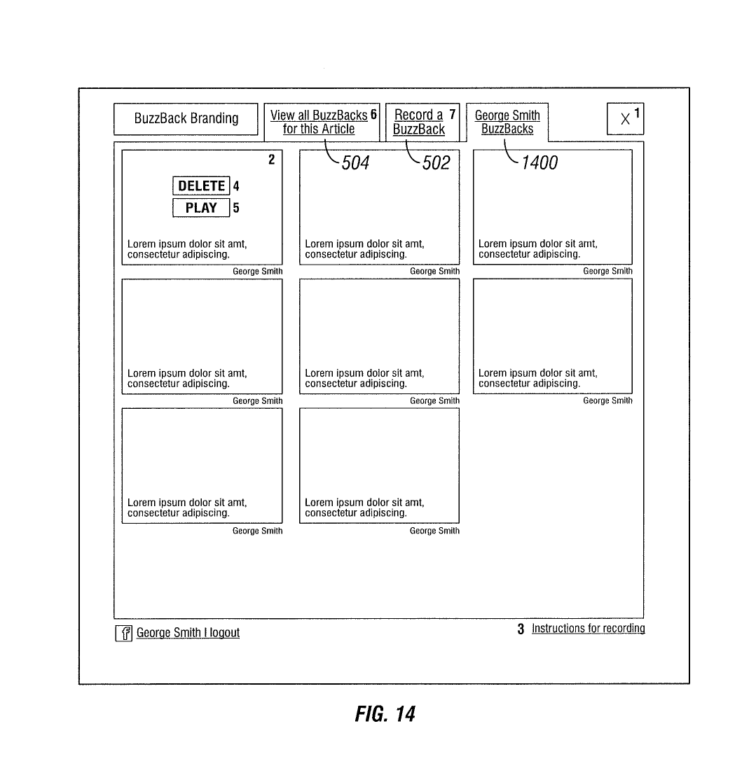

FIG. 14 shows an example screen shot where the user has been authenticated and has selected the my comments tab 1400. This allows the user to view each of the video comments that he/she has posted regardless of the source digital content. Alternatively, the my comments tab 1400 could show each of the video comments posted by that user for a particular source digital content. In some cases, the user may be allowed to play or delete his/her video comments from the screen.

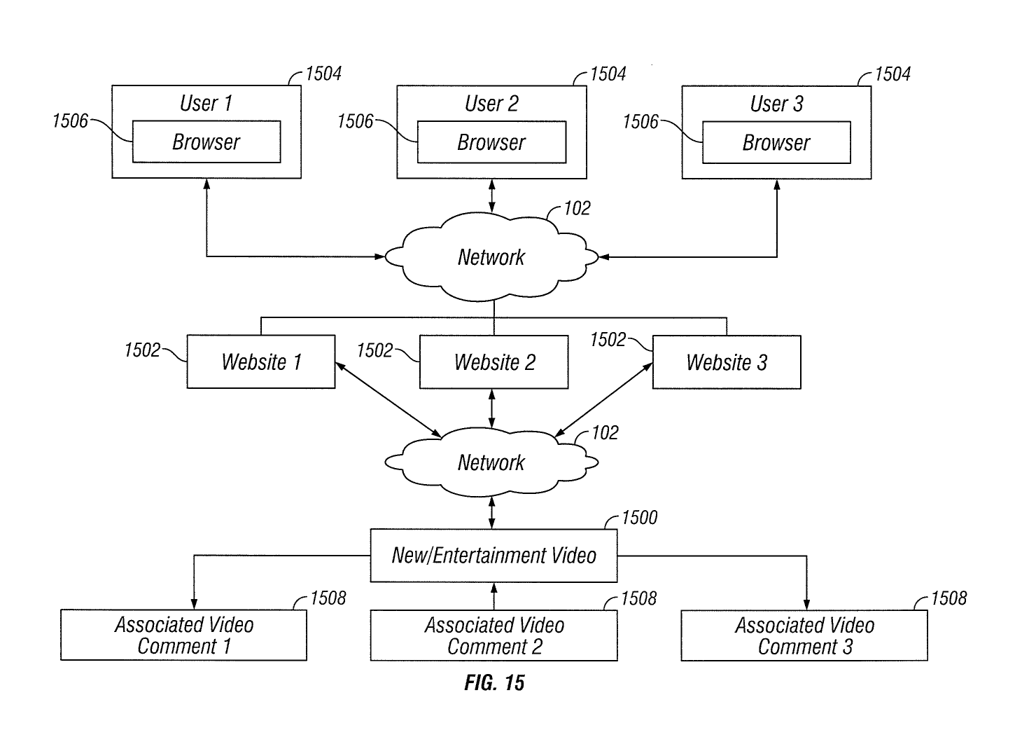

The system may be used in a wide variety of contexts and environments. For example, the system may be used in conjunction with distribution of news and/or entertainment content. Consider an example in which a content provider syndicates a news video to a plurality of websites. As shown in the example of FIG. 15, a news/entertainment video 1500 may be viewed on a plurality of websites 1502. For example, each of these websites may include an embed code on a webpage with a link to the source video 1500. When a user 1504 views one of these webpages, such as using a browser 1506, the source video 1500 may be played by the user. Although existing systems allow users to post comments about a video, each of these comments would exist separately on each website. In contrast, in one embodiment of the present system, the video comments 1508 associated with the source video 200 and may be displayed on any of the websites 1502.

In this manner, video comments posted about the source video 1508 on a first website may be displayed when a user reviews comments about the source video 1500 on a second website. This allows a greater dialogue about the source video 1500 to be communicated between the users. As explained below, one reason that the video comments can be decentralized is through the system's use of identification for the digital content and video comments in a central database. Even though the source video may be posted on a plurality of websites, it would have the same unique identifier in the database, which allows video comments posted from any of these websites to be associated with the source video.

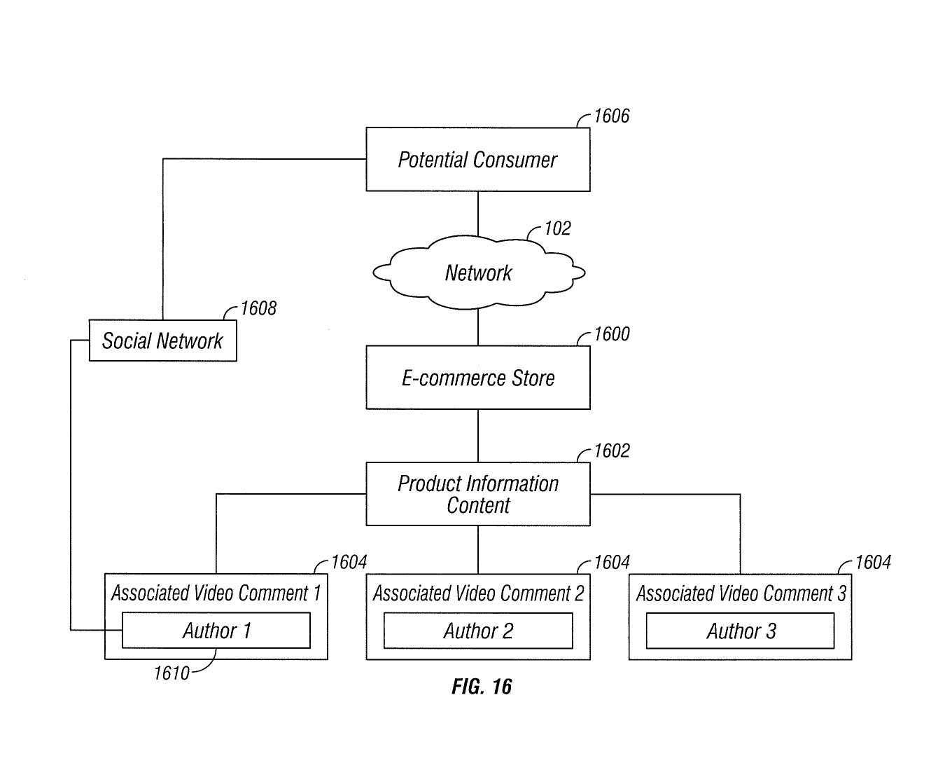

By way of another example, the system can be used in conjunction with one or more e-commerce stores. FIG. 16 shows an example use of the system in conjunction with an e-commerce store 1600, which includes product information content 1602, such as an image, text or video explaining features of a product sale on the e-commerce store 1600. As consumers purchase the product, these consumers are able to post a plurality of video opinions 1604 about the product that are associated with the product information content 1602. When a potential consumer 1606 of the product reviews the product information content 1602, the system allows the potential consumer to view the opinion videos 1604 from other consumers who have purchased the product prior to purchase.

In some embodiments, the relationship on a social network 1608 between the potential consumer 1606 and an author 1610 of an opinion video, such as being “friends” or “connected” on a social network, such as Facebook and Linkedin, could be taken into account in determining which video comments to display. This could be employed in a number of different ways. For example, in determining which of the plurality of video comments 1604 that is associated with the product information content 1602 to load and make viewable by the potential consumer, the system could use the social graph by Facebook™ in ranking the video comments 1604. The use of relationships in a social network to determine which video comments about a product to be displayed allows those that would have the most influence over the potential consumer 1606 to be viewed. In some cases, for example, these comments by those related to the social network could be highlighted or flagged for the potential consumer 1606 to view. Embodiments are also contemplated in which the system may trigger an alert to the potential consumer 1606 about a “friend” that has reviewed the product in an effort to influence the potential consumer to proceed with the transaction. For example, this alert may be triggered by a number of different actions by the potential consumer, such as, when the potential consumer selects a different product or if the potential consumer navigates away from the e-commerce store 1600.

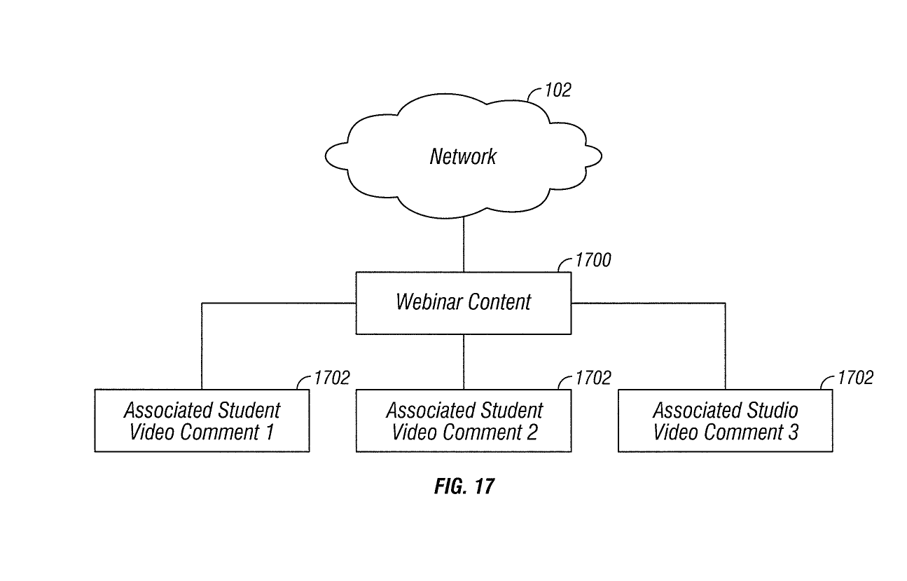

FIG. 17 shows an example use of the system in the context of an educational setting. In this example, an entity has included webinar content 1700, such as prerecorded video instruction, to be viewed by a plurality of students over a communications network 102. In this example, a plurality of student comments 1702 have been posted to the system and are associated with the webinar content 1700. By way of example, this may be used as a manner by which students can interact with others watching the webinar at a different time and/or place, annotate presentations in the webinar, and respond to content in the webinar or other materials.

The following is a non-exhaustive list of other uses that could be made of the system:
User generated product and company reviews and recommendations—users can use the system to record their opinion of and experience with products, services, companies and online services.
Advertising based customer endorsements—users can use the system to promote companies, products, services and businesses
Sweepstakes or contest based promotions—the system can be used to create video recording contests such as who makes the most passionate and exciting plea or case about almost any topic to win a prize.
Sales pitch feedback—the system can be used by sales people to practice sales pitches and receive feedback from managers.
Customer engagement and loyalty optimization—the system can increase the frequency in which readers or web site visitors return to a web site.
Content monetization—the system can be linked to source videos which have pre-roll or post-roll advertisements and consequently increase review.
Revenue optimization and conversion—video comments can be shared or posted on social networks for social graph members to view and click through to related source video (ad revenue) or products (e-commerce rev).
General corporate feedback systems for product development and business performance optimization—the system can be used by employees, partners and customers of companies to provide feedback on products, processes and service.
Internal corporate communications—the system can be used to share internal corporation information especially in disparate corporations.
Corporate training applications—the system can be used to solicit employee responses and answers to corporate training programs.
Corporate/institutional knowledge transfer and memorialization—the system can be used to archive corporate best practices or other important corporate information.
Product and service co-creation (collaboration) service—the system can be used to invite customers, partners and employees to collaborate on the development of new products and services.
Product testing (focus groups)—the system can be used to solicit employee, customer and partners opinions on new products.
Marketing campaign testing (broadcast, print, etc.)—the system can be used to solicit employee, customer and partners opinions on new advertising, marketing or promotions/campaigns.
Human resources interviewing—the system can be used by HR departments for distant or remote interviewing or question and answering.

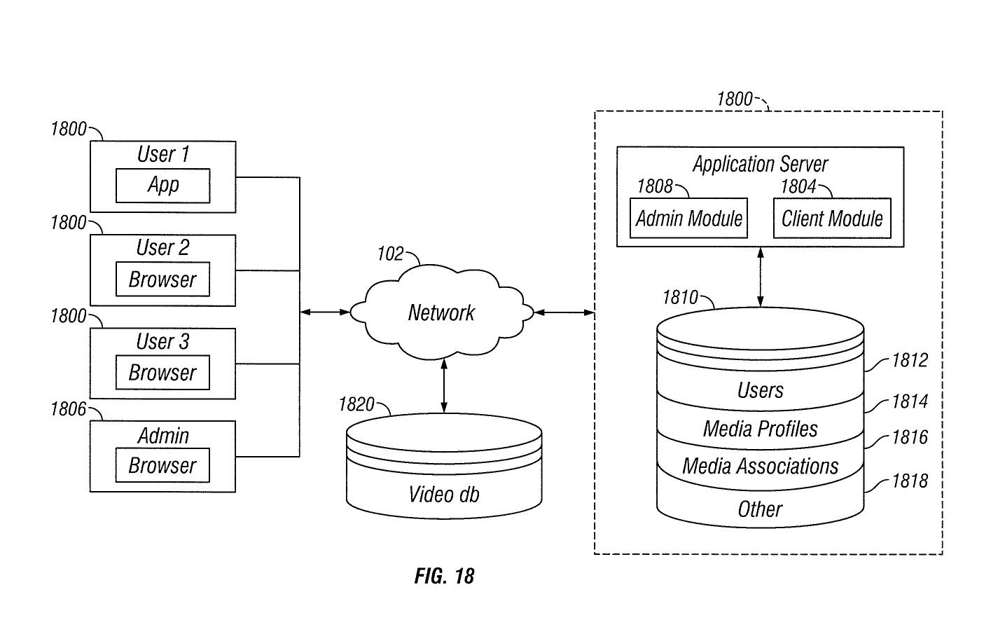

FIG. 18 is a diagrammatic representation of a system 1800 that could perform one or more of the functions described above according to one embodiment. In this example, a plurality of user machines 1802 (although 3 are shown for purposes of example, one or more than one could be provided) are able to connect to the system 1800 via a network 102. As discussed above, the system 1800 could be accessed using an embed code in a webpage or using a dedicated application. For example, the user may select an element on a webpage, such as shown in FIG. 3, to launch an application. In this example, the application could have one or more of the functions available in the client module 1804 to view and post video comments. For example, the application could be a Flash™ (Adobe Systems Incorporated of San Jose, Calif.) based application with PHP scripting that uses web services, such as RESTFul web services, on the application server 1800 and returns results to the user's browser. Alternatively, a user machine 1802 may have a dedicated application stored on-board that accesses one or more functions of the client module 1804 using web services via the network 102. For example, the user machine 1802 could be a tablet device or smart phone, such as an iOS™ (Apple Inc. of Cupertino, Calif.) or Android™ (Google Inc. of Mountain View, Calif.) device, that has an “app” loaded thereon which is capable of accessing one or more functions of the client module 1804.

FIG. 18 also shows an administrative user 1806 that may perform various administrative functions using the admin module 1806, including but not limited to, adding additional source content, assigning channels to the source content, managing content providers, and/or possibly other administrative functions. An administrative user may be a content provider seeking to add source digital content to the database and obtain one or more embed codes that could be inserted into a webpage for launching the client application. Additionally, an administrative user could be managing the application server itself to add content providers, manually add source content, and other types of management. In some embodiments, the administrative user 1806 may access a website that includes an application, such as a PHP based application, that uses web services to access various functions of the admin module 1808.

Typically, the admin module 1808 and the client module 1804 are configured to store various types of data in a database 1810. In the example shown, the database 1810 includes information about users 1812, media profiles 1814, media associations 1816, and other data 1818. The user data 1812 may include information about content providers and users that post video comments, such as an identification, username, and password. In this manner, each content provider and user may be uniquely identified in the database 1810. The media profiles 1814 may include information regarding each of the videos, such as a unique identification, source URL, category type, title, description and other information about each video. Additionally, each video may be keyed with a user identification of the author. The media associations 1816 set forth which source content is associated with videos comments. Other data 1818 may be used as well by the client module 1804 and the admin module 1808. In the example shown in FIG. 18, the video content is stored in a separate content delivery system 1820, which could communicate with the application server 1800 through the network 102. Embodiments are also contemplated in which the content delivery system 1820 may be integrated with the application server 1800.

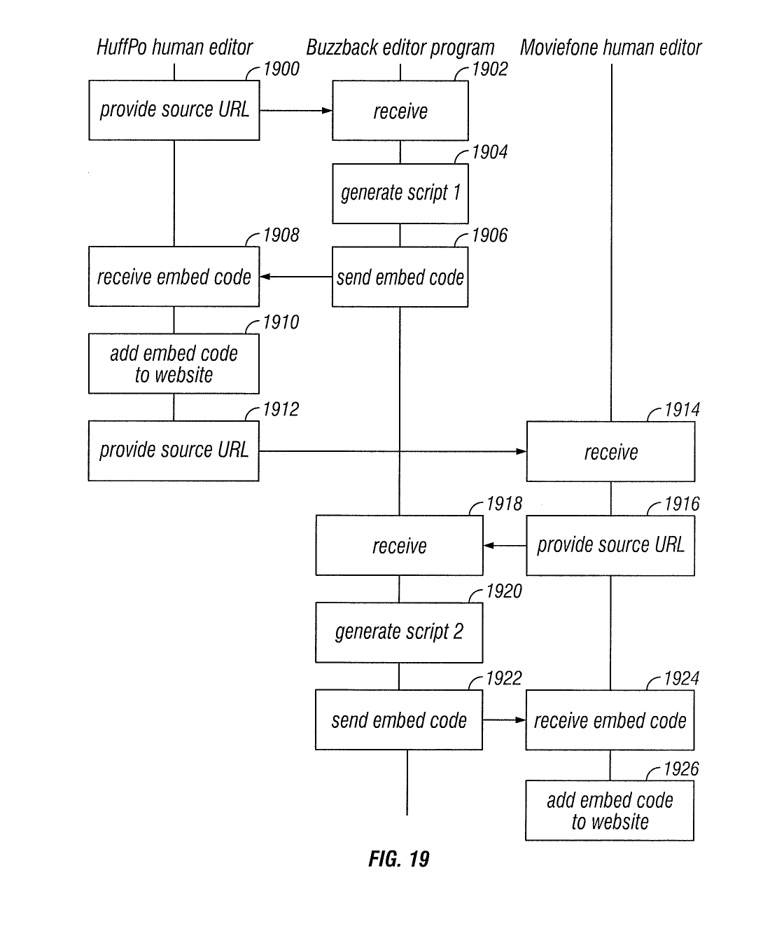

FIG. 19 illustrates a flow chart showing possible actions of a first content provider, the admin module 1808, and a second content provider. In this example, a first content provider (labeled “HuffPo human editor” in this example) provides a source URL for source digital content, such as a video (block 1900), which is received by the admin module 1808 (labeled “Buzzback editor program”). In response to receiving the URL for source digital media content (block 1902), the admin module 1808 generates a script, such as an embed code, (block 1906) which is then provided to the first content provider (block 1908). Typically, admin module 1808 is configured to generate a script that could be inserted into the desired location in the HTML of a web page (block 1910) and be associated with an element that the user may select to launch an application that provides one or more features of the client module 1804, such as the element 300 shown in FIG. 3. Typically, the admin module 1808 communicates with the database 1810 to store an identification of the content provider, create a media profile, including a unique identification for the source content, and proper associations. In some cases, the script that is generated will include a unique identification for the content provider that submitted the source content and a unique identification for the source content.

In the example shown, the first content provider has communicated the source URL to a second content provider (labeled “Moviefone human editor”) via a communications network (block 1912), which is received by the second content provider (block 1914). This may be provided by the second content provider to the admin module 1808 (blocks 1916 and 1918). The admin module generates a script, such as an embed code, that includes an identifier for the second content provider and the source content (block 1920). This embed code is sent to the second content provider via a communications network (block 1922). Upon receipt of the embed code (block 1924), this can be added to the website (block 1926) so the user may select an element that launches the application that accesses the client module 1804, which allows users to view and post video comments associated with the digital content. Since the source content has the same identifier in the database, comments posted on both the first content provider and second content provider's websites will be associated with the source content. Likewise, video comments posted through the client module 1804 on the first content provider's website will be available for viewing by users on the second content provider's website.

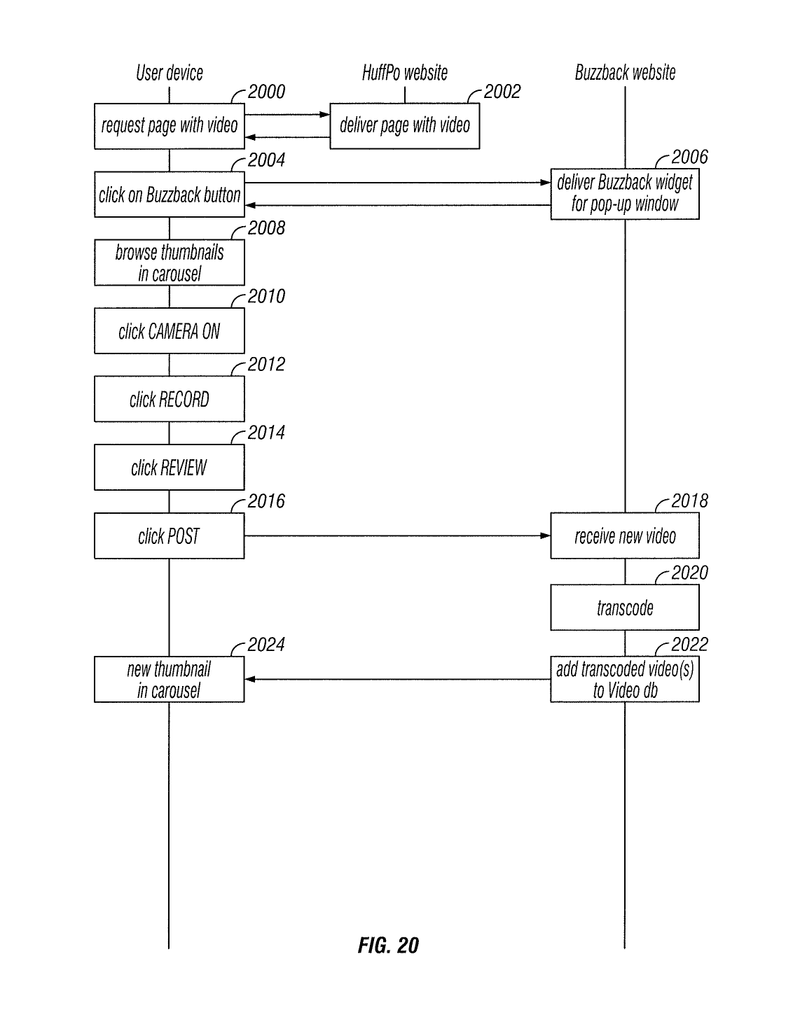

FIG. 20 is a flow chart showing possible actions that may occur for a user to view and/or post a video comment using an embodiment of the system. In this example, the user requests a webpage that includes video (block 2000), such as by using a web browser. The requested webpage on the content provider's website (labeled “HuffPo website” in this example) is delivered to the user (block 2002) and is available for the user to play in the browser, such as by using a media plug-in. An element (labeled “Buzzback button” in this example) that may be selected by the user is associated with the video. Upon selecting this element (block 2004), the application launches to allow the user to view and/or post video comments (block 2006). For example, the client module 1804 may retrieve a plurality of video comments associated with the source video. As discussed above, the source content would be assigned a unique identifier, which allows the unique identifiers of the video comments to be associated with the source content. These video comments may be browsed by the user (block 2008). Through the application, the user may turn on the camera and record a response video (blocks 2010 and 2012). Upon recording the video, the user may review the video to determine whether it is acceptable (block 2014). If the video is acceptable to the user, the application allows the user to post the video (block 2016); the posting information is received by the application server 1800 (block 2018). The application server 1800 transcodes the video (block 2020), such as using the Zencoder™ encoding server by Zencoder, Inc. of San Francisco, Calif., to various formats, such as H.264 and/or MP4, and adds the transcoded video to the video database 1820 (block 2022). This adds the thumbnail of the recorded video to the other video comments (block 2024). In some cases, if another user responds to the video comment posted by the user, a notification may be sent so the author of the original comment can post a response.

Embodiments are contemplated in which the system may include a video crawler feature. For example, an application may crawl video websites seeking video clips meeting certain criteria (e.g., total run time, category, etc.). Any videos meeting these criteria may be assigned a unique identifier and then be published to a video application.

In some embodiments, the video comments may be screened prior to being posted for other users to view. In one embodiment, a hybrid moderation system could be used that employs automated filtering solutions combined with human moderation. For example, user submitted video comments could be scanned by technological filters and/or made available for analysis by the community. The technological filter assigns either a pass/fail or a score to the content. A score may be utilized to provide an adjustable filter. Relevant information considered in the filter may include, but is not limited to: (i) Meta-data associated with content (e.g., user reputation/history, specific high-risk originating source, high-risk topics, time and geographic location of posting) and (ii) the audio content can be analyzed for inappropriate material with either text-to-speech with a dictionary/phrase library blacklist or related filter, or directly with phoneme analysis. In some cases, the video portion of the content could be scanned as well. As video in digital form is merely a sequence of frames, it is likely that any analysis will be on an image basis, not of motions in any video. Additionally, the community views the video and is provided with a mechanism for flagging/reporting. For more effective content discrimination it is advisable to provide the user the ability to specify reasoning if appropriate. Another possible screening mechanism could be employee random sampling, perhaps weighted utilizing meta-data to provide much the same purpose as above, but perhaps with greater specificity. A video meeting a set of criteria from the above filters may be designated for employee moderation or perhaps heightened calls for community moderation. A combined tally is taken of the approaches above, providing an overall pass/fail. The video can be removed from all viewings or, if a score or other specificity is employed, perhaps filtered out depending on: connection to viewer (social ‘friends’), designated sensitivity of viewer, preferences of originating website/content provider, etc. Other approaches may include a select set of perhaps self-designated “moderators”—individuals from the community or original content sites who may have special initial access to videos before going public.

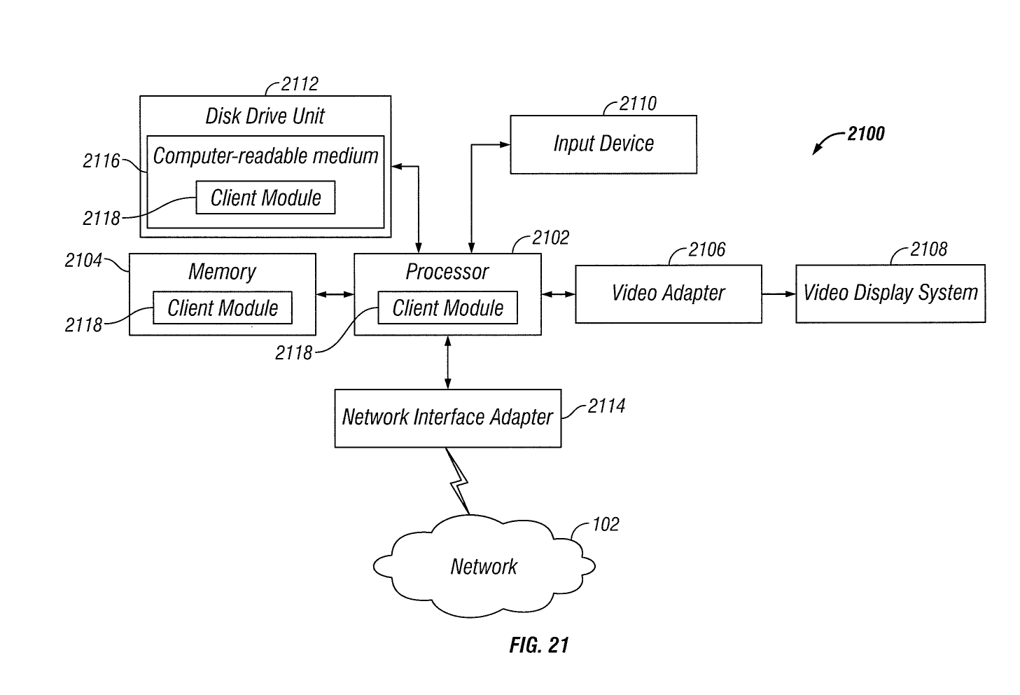

FIG. 21 illustrates a diagrammatic representation of a machine 2100 in the example form of a computer system that may be programmed with a set of instructions to perform any one or more of the methods discussed herein. The machine may be a personal computer, a notebook computer, a server, a tablet computer, a personal digital assistant (“PDA”), a cellular telephone, or any machine capable of executing a set of instructions (sequential or otherwise) that specify actions to be taken by that machine. Although only a single machine is illustrated in FIG. 21, the term “machine” shall also be taken to include any collection of machines that individually or jointly execute a set (or multiple sets) of instructions to perform any one or more of the methods discussed herein.

The example machine 2100 illustrated in FIG. 21 includes a processor 2102 (e.g., a central processing unit (“CPU”)), a memory 2104, a video adapter 2106 that drives a video display system 2108 (e.g., a liquid crystal display (“LCD”) or a cathode ray tube (“CRT”)), an input device 2110 (e.g., a keyboard, mouse, touch screen display, etc.) for the user to interact with the program, a disk drive unit 2112, and a network interface adapter 2114. Note that various embodiments of the machine 2100 will not always include all of these peripheral devices.

The disk drive unit 2112 includes a computer-readable medium 2116 on which is stored one or more sets of computer instructions and data structures embodying or utilized by the modules (the client module is shown in this figure for purposes of example) described herein. The computer instructions and data structures may also reside, completely or at least partially, within the memory 2104 and/or within the processor 2002 during execution thereof by the machine 2100; accordingly, the memory 2104 and the processor 2102 also constitute computer-readable media. Embodiments are contemplated in which the modules may be transmitted or received over the network 102 via the network interface device 2114 utilizing any one of a number of transfer protocols including but not limited to the hypertext transfer protocol (“HTTP”) and file transfer protocol (“FTP”).

The network 102 may be any type of communication scheme including but not limited to fiber optic, cellular, wired, and/or wireless communication capability in any of a plurality of protocols, such as TCP/IP, Ethernet, WAP, IEEE 802.11, or any other protocol. For example, the modules could be accessed from the application server 1800 via the network 102 using a browser program, such as Internet Explorer™ by Microsoft Corporation of Redmond, Wash., or Safari™ by Apple Corp. of Cupertino, Calif.

While the computer-readable medium 2116 shown in the example embodiment of FIG. 21 is a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing a set of instructions for execution by the machine and that cause the machine to perform any one or more of the methods described herein, or that is capable of storing data structures utilized by or associated with such a set of instructions. The term “computer-readable medium” shall accordingly be taken to include, but not be limited to, solid-state memories, optical media, flash memory, and magnetic media.

Although the present invention has been described with reference to particular means, materials and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A computerized video commenting system comprising:
a non-transitory computer-readable medium having a computer program code stored thereon;
a database including one or more records that establish a relationship between a video commenter identification, one or more video comment identifiers associated with the video commenter identification, and a source digital content identifier;
a processor in communication with the computer-readable memory configured to carry out instructions in accordance with the computer program code, wherein the computer program code, when executed by the processor, causes the processor to perform operations comprising:
receiving a request to post a video comment about source digital content, wherein the request includes a source digital content identifier that identifies the source digital content for which the video comment will be associated;
presenting a video posting interface configured to record and post a video comment about the source digital content, wherein the video posting interface includes a login portion and a post selection portion;
verifying login credentials received from the login portion;
determining a video commenter identification in the database based on the login credentials;
responsive to selection of the post selection portion, storing in the database a new video comment identifier associated with a new video comment;
associating the new video comment identifier with the video commenter identification and the source digital content identifier; and
posting the new video comment to a database accessible via a communications network.

2. The computerized video commenting system of claim 1, wherein the video posting interface includes a my comments portion, wherein the processor is configured to present from the database one or more video comments associated with the video commenter identification responsive to selection of the my comments portion.

3. The computerized video commenting system of claim 2, wherein selection of the my videos portion is configured to present video comments associated with the video commenter identification from multiple source digital content identifiers.

4. The computerized video commenting system of claim 1, wherein the video posting interface is configured to limit a length of a video comment to a maximum video length.

5. The computerized video commenting system of claim 5, wherein the video posting interface includes a length identifier configured to show an amount of time remaining until the maximum video length is reached.

6. The computerized video commenting system of claim 5, wherein the maximum video length is approximately 15 seconds.

7. The computerized video commenting system of claim 1, wherein the video posting interface shows a view of a video during recording.

8. The computerized video commenting system of claim 1, wherein the processor is configured to score the new video comment for potentially offensive content prior to posting the new video comment.

9. The computerized video commenting system of claim 8, wherein the processor is configured to score the new video comment concerning offensive content is based on metadata associated with one or more of: (1) the source digital content; the new video comment; or (3) a profile history associated with the video commenter identification.

10. The computerized video commenting system of claim 9, wherein one or more of the following types of metadata are used to score the new video comment for offensive content: (1) an origin of the source digital content determined to be high risk for offensive content; (2) one or more topic identifiers associated with the source digital content determined to be high risk for offensive content; (3) a time of receiving the request to post a video comment; (4) a geographic location from which the request to post a video comment was received.

11. The computerized video commenting system of claim 8, wherein the processor is configured to score the new video comment concerning offensive content based on an analysis of audio content associated with new video comment.

12. The computerized video commenting system of claim 11, wherein the analysis of the audio content is performed by one or more of the following: (1) converting the audio content to text and searching for objectionable words with a library of blacklisted words or phrases; or (2) a phoneme analysis.

13. A computerized system video for delivering digital content over a communications network, the system comprising:
a database including one or more records that establish a relationship between a source content identifier, one or more channel identifiers associated with the source digital content identifier, and a content provider identifier associated with the source digital identifier.
an application server on a computer including an administrative module configured to assign a source content identifier to a source digital content file, assign one or more channel identifiers to the source content identifier, and assign a content provider identifier to the source content identifier; and
wherein responsive to a request on the application server associated with a content provider identifier to add a new source digital content file, the administrative module is configured to assign the new source digital content file with a new source content identifier, generate a script that includes the new source content identifier and associate the new source content identifier with the content provider identifier in the database.

14. The computerized system of claim 13, wherein the script is an embed code.

15. The computerized system of claim 14, wherein the embed code is configured to be inserted in a web page.

16. The computerized system of claim 14, wherein the embed code is configured to launch an application for submitting a video comment concerning the new source content file.

17. The computerized system of claim 13, further comprising a client module configured to assign a video comment identifier to a video comment file, assign a user identifier to the video comment identifier, and assign a source content identifier to the video comment identifier.

18. The computerized system of claim 17, wherein responsive to a request on the application server associated with a user identifier to add a new video comment file concerning a source content file, the client module is configured to assign the new video comment file with a new video comment identifier and associate the new video comment identifier with the source content file in the database.

19. The computerized system claim 17, wherein the client module includes a video crawler feature that seeks video clips meeting pre-determined criteria and the client module is configured to add any video clips found by the video crawler feature to the database.

20. A computerized system for delivering digital content over a communications network, wherein the system comprises:
a non-transitory computer-readable medium having a computer program code stored thereon;
a database including one or more records that establish a relationship between a source digital content file and one or more video comments associated with the source digital content file;
a processor in communication with the computer-readable memory configured to carry out instructions in accordance with the computer program code, wherein the computer program code, when executed by the processor, causes the processor to perform operations comprising:
receiving a request for the source digital content file via a communications network, wherein the request includes one or more parameters indicative of a source content file;
identifying whether the source digital content file is associated with any video comments;
sending a response via a communications network with an address for the source digital content file and an address for the one or more video comments associated with the source digital content file.
